(19) United States
(12) Patent Application Publication
(10) Pub. No.: US 2026/0241582 A1
(43) Pub. Date: Aug. 20, 2026

(54) WEIGHING SENSOR ASSEMBLY, PICKUP TOOLING, MANIPULATOR AND ROBOT

(71) Applicant: BEIJING JINGDONG QIANSHI TECHNOLOGY CO., LTD., Beijing (CN)

(72) Inventors: Jian ZHANG, Beijing (CN); Xu LIU, Beijing (CN); Yunjian CHENG, Beijing (CN); Guoku SONG, Beijing (CN); Ying CHEN, Beijing (CN)

(21) Appl. No.: 18/859,479

(22) PCT Filed: Apr. 19, 2023
(86) PCT No.: PCT/CN2023/089096

§ 371 Date: Oct. 23, 2024

(30) Foreign Application Priority Data
Apr. 25, 2022 (CN) 202210438409.6

(51) Int. Cl. B25J 15/06; B25J 19/02; G01G 3/14

(52) U.S. Cl. CPC B25J 15/0616; B25J 19/02; G01G 3/14

(57) ABSTRACT

A weighing sensor assembly, a pickup tooling, a manipulator and a robot. The weighing sensor assembly comprises a first hollow pipe, and at least two weighing sensors, which are evenly arranged on a circumferential outer side of the first hollow pipe at intervals, wherein the at least two weighing sensors are connected to the first hollow pipe. In a weighing sensor assembly according to the present disclosure, a first hollow pipe is arranged in an intermediate portion to allow air communication at the intermediate portion, such that the weighing sensor assembly can be arranged at any position without affecting arrangement of a vacuum air path, thereby improving the arrangement flexibility.

### CROSS-REFERENCE TO RELATED APPLICATIONS

The present disclosure is based on and claims priority to the CN application No. 202210438409.6 filed on Apr. 25, 2022, which is hereby incorporated by reference in its entirety into the present disclosure.

### TECHNICAL FIELD

The present disclosure relates to a weighing sensor assembly, a pickup tooling, a manipulator and a robot.

### BACKGROUND

A pickup tooling is an important part of a manipulator, which uses a grasping portion to grasp an article, so as to transport the article from one position to a designated position. According to different scenes, types and weights of articles grasped by the pickup tooling are different, and the weights of the articles need to be measured in some occasions. In the prior art, the weights of the grasped articles are mainly measured by a weighing sensor mounted to the pickup tooling. For example, in a picking process of the pickup tooling, the number of articles grasped by the pickup tooling can be obtained through a standard weight of a single article and a measured total weight of the grasped articles.

Types of grasping portions of existing pickup toolings mainly include mechanical claws and suckers. For a sucker-type pickup tooling, it requires arranging a vacuum air path and a weighing sensor, and how to provide an appropriate arrangement of the vacuum air path and the weighing sensor is a problem that needs to be solved.

It should be noted here that the statement in the background portion only provides background art related to the present disclosure and does not necessarily constitute the prior art.

### SUMMARY

The present disclosure provides a weighing sensor assembly, a pickup tooling, a manipulator and a robot, so as to improve the flexibility of position arrangement of the weighing sensor on the pickup tooling.

On a first aspect, the present disclosure provides a weighing sensor assembly including a first hollow pipe, and at least two weighing sensors, which are circumferentially and evenly arranged on an outer side of the first hollow pipe at intervals, wherein the at least two weighing sensors are connected to the first hollow pipe.

In some embodiments, the weighing sensor assembly further includes a connecting basebase arranged at at least one of axial ends of the first hollow pipe, and the connecting base connecting at least two weighing sensors and the first hollow pipe.

In some embodiments, the weighing sensor assembly includes a first connecting base and a second connecting base arranged respectively at the axial ends of the first hollow pipe, wherein the first connecting base has a first throughhole and the second connecting base has a second throughhole, and the first hollow pipe is hermetically connected with the first throughhole and the second throughhole.

In some embodiments, the first hollow pipe is integrally formed with the first connecting base.

In some embodiments, the second connecting base includes a connecting base body and an intermediate connecting pipe arranged on the connecting base body, and an inner cavity of the intermediate connecting pipe forms the second throughhole.

In some embodiments, an end of the intermediate connecting pipe away from the first hollow pipe extends beyond a surface of the connecting base body in an axial direction.

In some embodiments, the first hollow pipe is connected with the intermediate connecting pipe through a sealing ring.

On a second aspect, the present disclosure provides a pickup tooling including a sucker, a second hollow pipe and said weighing sensor assembly, wherein the sucker includes a sucker body for sucking an article and a suction tube arranged at an upper end of the sucker body, and the second hollow pipe is configured to be connected with a vacuum generator to provide a negative pressure for the sucker; wherein the weighing sensor assembly is arranged between the suction tube and the second hollow pipe, a lower end of a weighing sensor is connected with the suction tube, and an upper end of each weighing sensor is connected with the second hollow pipe; wherein the suction tube, the first hollow pipe and the second hollow pipe are in air communication sequentially.

In some embodiments, the first hollow pipe is coaxially arranged with the second hollow pipe, and an inner diameter of the first hollow pipe is smaller than that of the second hollow pipe.

In some embodiments, the weighing sensor assembly is arranged adjacent to the sucker.

On a third aspect, the present disclosure provides a manipulator including said pickup tooling.

On a fourth aspect, the present disclosure provides a robot including said manipulator.

According to various aspects of the present disclosure, the weighing sensor assembly includes a first hollow pipe, and at least two weighing sensors, which are circumferentially and evenly arranged on an outer side of the first hollow pipe at intervals, wherein the at least two weighing sensors are connected to the first hollow pipe. In a weighing sensor assembly according to the present disclosure, a first hollow pipe is arranged at the center to allow air communication at the center, such that the weighing sensor assembly can be arranged at any position without affecting arrangement of a vacuum air path, thereby improving the arrangement flexibility.

By means of the detailed description below of exemplary embodiments of the present disclosure with reference to the drawing attached thereto, further features and advantages of the present disclosure will become clearer.

### BRIEF DESCRIPTION OF THE DRAWINGS

The drawings attached thereto are intended to provide further understanding of the present disclosure, which drawings constitute part of the present disclosure. Exemplary embodiments of the present disclosure and description thereof are intended to interpret the present disclosure, which do not constitute inappropriate limitation over the present disclosure. In the drawings:

FIG. 1 is a schematic structural diagram of a pickup tooling of a related art.

FIG. 2 is a schematic diagram of an air path of the pickup tooling shown in FIG. 1.

FIG. 3 is a schematic structural view of the pickup tooling shown in FIG. 1 when subjected to a lateral force.

FIG. 4 is a schematic diagram of a structure and an air path of the tooling with lower-disposed weighing sensors.

FIG. 5 is a schematic structural diagram of a pickup tooling according to an embodiment of the present disclosure.

FIG. 6 is a schematic view of a three-dimensional structure of the weighing sensor assembly in FIG. 5.

FIG. 7 is a schematic diagram of an internal structure of the weighing sensor assembly shown in FIG. 6.

FIG. 8 is a schematic diagram of the air path of the pickup tooling assembly according to an embodiment of the present disclosure.

### DETAILED DESCRIPTION OF PREFERRED EMBODIMENTS

With reference to the figures of the embodiments of the present disclosure, a clear and complete description is given below for the technical solutions of the embodiments of the present disclosure. Obviously, the embodiments described below are only part of the embodiments, rather than all of the embodiments. The below description of at least one exemplary embodiment is actually only illustrative and should by no means be taken as any restriction over the present disclosure and its application or use. All other embodiments that can be obtained by a person skilled in the art based on the embodiments of the present disclosure without any creative effort are included in the protection scope of the present disclosure.

Unless otherwise specified, elements and arrangement of steps relative to one another, numeric expressions and values recited in these embodiments do not restrict the scope of the present disclosure. Besides, it should be understood that, in order to facilitate illustration, dimensions of elements shown in the drawings are not given according to the actual scaling relation. For technology, process and apparatus already known by a person skilled in the related art, detailed discussion may not be given, but if appropriate, such technology, process and apparatus should be regarded as part of the description. In any example shown or discussed here, any specific value should be interpreted only as being exemplary, rather than being restrictive. Thus, other examples of exemplary embodiments may have different values. It should be noted that, as like reference signs in the below figures denote like elements, once an element is defined in a figure, it does not need to make further discussion for it in a subsequent figure.

For the convenience of description, spatially relative terms such as “over”, “above”, “on an upper surface of”, “on”, etc. can be used here to describe the spatial positional relationship between a device or feature as shown in the figure and other devices or features. It should be understood that spatially relative terms are intended to encompass different orientations in use or operation in addition to the orientation of the device depicted in the drawings. For example, if a device in a figure is inverted, the device described as “above” or “over” other devices or structures will be positioned as “under” or “below” other devices or structures. Therefore, the exemplary term “above” can include both directions of “above” and “below”. The device can also be positioned in other different manners, and the spatial relative description used here is explained accordingly.

A pickup tooling is a grasping device, which is usually connected to an end of a manipulator and configured for grasping an article. In the field of logistics, a manipulator is often used to pick up goods through the pickup tooling to realize selection of goods.

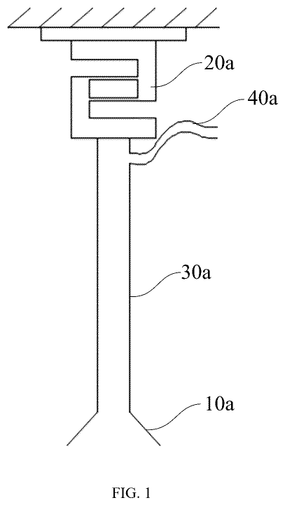

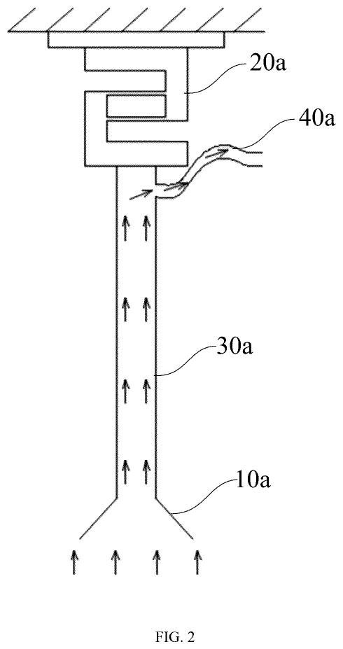

As shown in FIG. 1, a pickup tooling for picking up an article by vacuum suction includes a sucker 10a, a hollow pipe 30a and an air tube 40a. The air tube 40a is connected to a vacuum generator. When picking up an article, the sucker 10a is in direct contact with the article to pick up the article. In order to enable measurement and acquisition of a weight of the picked article, as shown in FIG. 1, the pickup tooling further includes a weighing sensor 20a arranged at an end of the manipulator. As shown in FIG. 2, when picking up an article, the vacuum generator sucks to cause an air flow in a direction of arrow as shown in FIG. 2, to generate a negative air pressure in the sucker 10a, such that the article can be firmly sucked, and then, transportation of the article can be started.

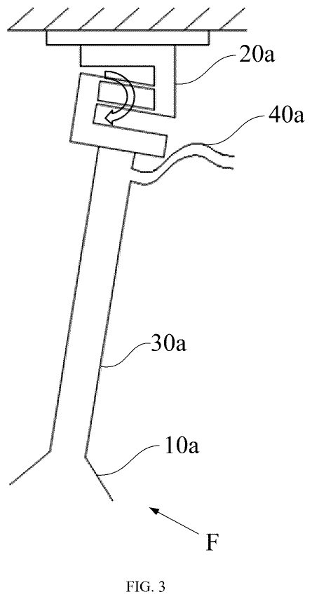

In the course of study, the inventor found that, in an actual picking process, different postures of the picked article may cause the pickup tooling to be subjected to various forces in different directions, such as the state shown in FIG. 3, where the pickup tooling is subjected to a lateral force F, and the weighing sensor 20a at the top generates a torsional force internally under the lateral force F. However, as a vertical downward direction is the optimal direction of the force to which the weighing sensor 20a is subjected, the weighing sensor 20a is prone to damage under action of the torsional force.

Moreover, in order to ensure the accuracy of the weight measurement when the grasped article is light, a sensor with a small range is generally selected, whereby the sensor will become a weak point while ensuring the accuracy, and it is more likely to be damaged when it is subjected to the torsional force as described above.

The inventor further studied the above problem and found that, as the sucker 10a of the pickup tooling is configured to suck an article, the sucker 10a is a portion that directly contacts the article, and is also a point where the lateral force F acts. Then, in the pickup tooling shown in FIG. 3, the weighing sensor 20a is arranged at an end away from the sucker 10a, which may cause the weighing sensor 20a to experience a greater torsional moment of force. Then, if one desires to reduce the torsional moment of force of the weighing sensor 20a to reduce damage to the weighing sensor, the force arm can be reduced by moving the weighing sensor down and arranging it adjacent to the sucker.

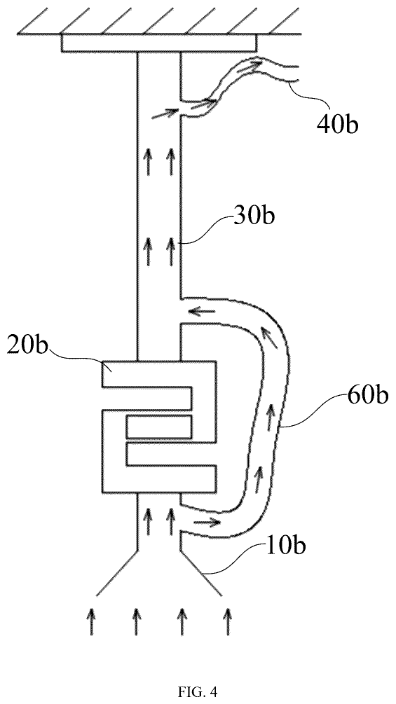

Based on the above consideration, as shown in FIG. 4, in this pickup tooling, the weighing sensor 20b is arranged at a position adjacent to the sucker 10b. Here, an air port of the sucker 10b can communicate with the hollow pipe 30b at an upper end of the weighing sensor 20b through an adapter air tube 60b, and the hollow pipe 30b is in communication with the air tube 40b, so that the air path flows in a direction of the sucker 10b, the connector tube 60b, the hollow tube 30b and the air tube 40b, and then to the vacuum generator to generate vacuum. As shown in FIG. 4, the two ends of the connector tube 60b are connected respectively to upper and lower ends of the weighing sensor 20b, so that elasticity and state of the connector tube 60b will affect the accuracy of the weighing sensor 20b. In the embodiment shown in FIG. 4, the weighing sensor 20b has one side provided with an connector tube 60b, and the connector tube 60b will generate a small force on the side of the weighing sensor 20b. If the connector tube 60b is provided to be short, a greater force will be exerted on the side of the weighing sensor 20b. However, if the connector tube 60b is provided to be long, it will occupy too much space and increase the interference space.

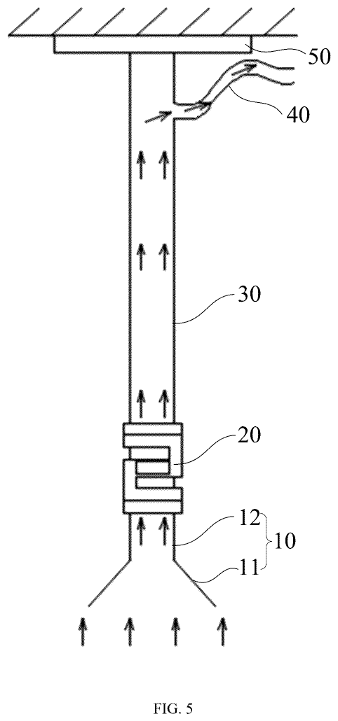

In view of the above problem, the inventor of the present disclosure has further studied and proposed that at least two weighing sensors can be arranged in combination, with a hollow pipe for air communication arranged therebetween, so that communication of the air path will not be affected with lower-disposed weighing sensors. Next, according to FIGS. 5 to 8, structures of the weighing sensor assembly and the pickup tooling including the weighing sensor assembly according to some embodiments of the present disclosure will be described in detail.

Referring to FIG. 5, the pickup tooling of the embodiment of the present disclosure includes a sucker 10, a second hollow pipe 30, and a weighing sensor assembly 20. Wherein, the sucker 10 includes a sucker body 11 for sucking an article and a suction tube 12 arranged at an upper end of the sucker body 11. The second hollow pipe 30 is configured to be connected with a vacuum generator to provide a negative pressure for the sucker 10. The weighing sensor assembly 20 is disposed between the suction tube 12 and the second hollow pipe 30.

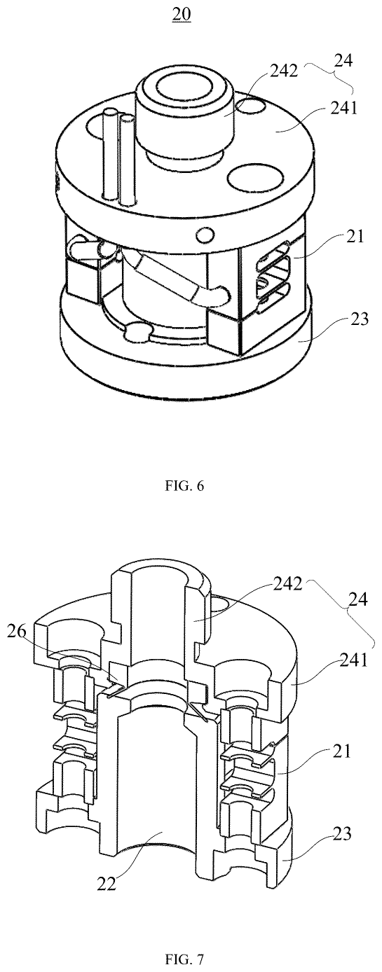

Referring to FIG. 6 and FIG. 7, the weighing sensor assembly 20 includes a first hollow pipe 22, and at least two weighing sensors 21 circumferentially and evenly arranged on an outer side of the first hollow pipe 22 at intervals. The at least two weighing sensors 21 are connected to the first hollow pipe 22. A lower end of the weighing sensor 21 is connected with the suction tube 12, and an upper end of the weighing sensor 21 is connected with the second hollow pipe 30, wherein the suction tube 12, the first hollow pipe 22 and the second hollow pipe 30 are in air communication sequentially.

In a weighing sensor assembly 20 according to an embodiment of the present disclosure, at least two weighing sensors 21 are evenly distributed outside, so that an center portion of the weighing sensor assembly 20 can form a space in air communication with the suction tube 12 and the second hollow pipe 30 at upper and lower ends, so that the first hollow pipe 22 is in air communication with the suction tube 12 and the second hollow pipe 30 to provide a negative pressure at the sucker body 11. Further, a lower end of the weighing sensor 21 is connected with the suction tube 12, and an upper end of the weighing sensor 21 is connected with the second hollow pipe 30, such that a weight of the article sucked by the sucker 10 can be transferred to the weighing sensor 21 through the suction pipe 11, thus enabling the weighing function of the weighing sensor 21. As can be known from the above, in a pickup tooling according to an embodiment of the present disclosure, there is provided a weighing sensor assembly 20 having an center portion for air communication, such that the weighing sensor assembly can be arranged at any position without affecting arrangement of a vacuum air path, thereby improving the arrangement flexibility.

In order to reduce the torsional moment of force of the weighing sensor and reduce the damage to the weighing sensor, in some embodiments, the weighing sensor assembly 20 is arranged adjacent to the sucker 10. The sucker 10, as a portion in direct contact with the article, is also a point where the force acts, such that arranging the weighing sensor assembly 20 adjacent to the sucker 10 can reduce a length of the force arm, further reduce the magnitude of the torsional moment on the weighing sensor, and further reduce the damage to the weighing sensor.

Further, compared with the pickup tooling of the embodiment shown in FIG. 4, the sum of ranges of at least two weighing sensors 21 in the embodiment of the present disclosure is the same as that of the weighing sensor 20b in FIG. 4, and that the range of each weighing sensor 21 is relatively small, thus ensuring the accuracy of weight measurement.

In the embodiment shown in FIGS. 5 to 7, the weighing sensor assembly 20 includes two weighing sensors 21 arranged oppositely. The two weighing sensors 21 are disposed respectively on two sides of the first hollow pipe 22, in symmetrical arrangement. In other embodiments not shown in the figures, the weighing sensor assembly 20 may also include more than three weighing sensors 21 evenly distributed with respect to a central axis of the first hollow pipe 22. As long as more than two weighing sensors 21 are evenly distributed in a circumferential direction of the first hollow pipe 22, the first hollow pipe 22 can form a passage for air communication from the suckers 10 to the second hollow pipe 30.

It can be seen from the above analysis that, on the one hand, two ends of each of the at least two weighing sensors 21 are connected respectively with the suction tube 12 and the second hollow pipe 30, so that a force exerted on the sucker 10 can be transmitted to the weighing sensors 21 through the suction tube 12 to enable their weighing function. On the other hand, the first hollow pipe 22 is in air communication with the suction tube 12 and the second hollow pipe 30 to allow an air flow and generate vacuum.

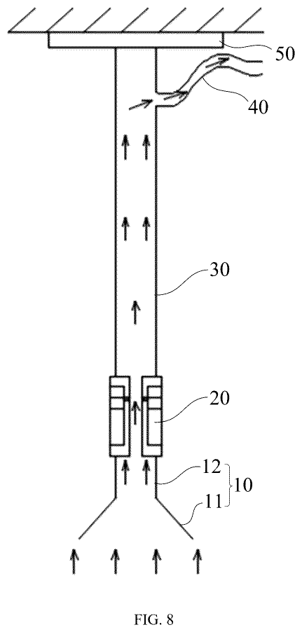

As shown in FIG. 8, the first hollow pipe 22, the suction tube 12 and the second hollow pipe 30 are hermetically connected in the air path to ensure airtightness of air communication.

In particular, in some embodiments, the suction tube 12, the first hollow pipe 22 and the second hollow pipe 30 are all coaxially arranged.

In some embodiments, the weighing sensor assembly 20 further includes a connecting base arranged at at least one of axial ends of the first hollow pipe 22. The connecting base connects the at least two weighing sensors and the first hollow pipe 22. Referring to FIGS. 6 and 7, for example, the weighing sensor assembly 20 may include a first connecting base 23 disposed at an axial lower end of the first hollow pipe 22. The lower ends of the at least two weighing sensors 21 and the lower end of the first hollow pipe 22 are all connected with the first connecting base 23, so that the first connecting base 23 is connected with the suction tube 12 of the sucker 10, the upper ends of the weighing sensors 21 are connected with the second hollow pipe 30, and the first hollow pipe 22 is hermetically connected with the second hollow pipe 30. For further example, the weighing sensor assembly 20 may also include a second connecting base 24 disposed at an axial upper end of the first hollow pipe 22. The upper ends of the at least two weighing sensors 21 and the upper end of the first hollow pipe 22 are all connected to the second connecting base 24.

Referring to FIGS. 6 and 7, in some embodiments, the weighing sensor assembly 20 includes a first connecting base 23 for connecting the weighing sensors with the suction tube 12 and a second connecting base 24 for connecting the weighing sensors 21 with the second hollow pipe 30. The first connecting base 23 has a first throughhole in fluid communication with the suction tube 12. The second connecting base 24 has a second throughhole in fluid communication with the second hollow pipe 30. The first hollow pipe 22 is hermetically connected with the first throughhole and the second throughhole.

The first connecting base 23 and the second connecting base 24 are separately arranged, so that the gravity of the article sucked by the sucker 10 can be transmitted to the weighing sensors 21 through the first connecting base 23.

A space where the weighing sensors 21 and the first hollow pipe 22 are arranged is formed between the first connecting base 23 and the second connecting base 24. In particular, the lower end of each weighing sensor 21 is connected with the first connecting base 23, and the suction tube 12 is connected with the first connecting base 23, so that the gravity of the article sucked by the sucker 10 can be transmitted to the weighing sensors 21 through the first connecting base 23. The upper end of each weighing sensor 21 is connected with the second connecting base 24, and the second connecting base 24 is connected with the second hollow pipe 30.

As shown in FIG. 8, when the weighing sensor assembly 20 is connected with the suction tube 12 and the second hollow pipe 30, the first connecting base 23 and the second connecting base 24 are structures for realizing direct connection with the suction tube 12 and the second hollow pipe 30. In particular, a tubular wall of the suction pipe 12 is connected with the first connecting base 23, so that a lumen of the suction tube 12 can communicate with the first throughhole on the first connecting base 23. Similarly, a tubular wall of the second hollow pipe 30 is connected with the second connecting base 24, so that a lumen of the second hollow pipe 30 can communicate with the second throughhole on the second connecting base 24. The first hollow pipe 22 located between the first connecting base 23 and the second connecting base 24 is hermetically connected with the first throughhole and the second throughhole, thereby realizing sealed communication of air from the suction tube 12 to the second hollow pipe 30.

In some embodiments, as shown in FIG. 7, the first hollow pipe 22 is integrally formed with the first connecting base 23. As so, when the first connecting base 23 is connected with the suction tube 12, the suction tube 12 can directly communicate with the first hollow pipe 22, and the integrated formation can better ensure the airtightness of the air communication.

As shown in FIG. 7, in some embodiments, the second connecting base 24 includes a connecting base body 241 and an intermediate connecting pipe 242 arranged on the connecting base body 241. An inner cavity of the intermediate connecting pipe 242 forms the second throughhole.

In particular, in an axial direction, an end of the intermediate connecting pipe 242 away from the first hollow pipe extends beyond a surface of the connecting base body 241, and the intermediate connecting pipe 242 is hermetically connected with the first hollow pipe 22. As so, air flows upward from the sucker 10, and passes sequentially through the first hollow pipe 22 and the intermediate connecting pipe 242 to arrive in the second hollow pipe 30.

In some embodiments, the first hollow pipe 22 is connected with the intermediate connecting pipe 242 through a sealing ring 26. In particular, a lower end surface of the intermediate connecting pipe 242 includes a stepped surface, and the sealing ring is clamped in the stepped surface.

In some embodiments, the first hollow pipe 22 is coaxially arranged with the second hollow pipe 30, and an inner diameter of the first hollow pipe 22 is smaller than that of the second hollow pipe 30. As so, the weighing sensor assembly 20 of this embodiment can achieve air communication without excessively increasing its volume.

An embodiment of the present disclosure further provides a manipulator including a pickup tooling of one of the above-mentioned embodiments.

An embodiment of the present disclosure further provides a robot including said manipulator. In particular, the robot may be a picking robot.

Next, the structure of the pickup tooling according to a specific embodiment of the present disclosure will be further described with reference to FIGS. 5 to 8.

As shown in FIG. 5, the pickup tooling of this embodiment includes a sucker 10, a weighing sensor assembly 20, a second hollow pipe 30, an air tube 40 and a mounting plate 50.

The sucker 10 includes a sucker body 11 and a suction tube 12. The sucker body 11 has a conical flaring structure, and the suction tube 12 is connected with the sucker body 11 and is in gas communication with the sucker body 11.

The weighing sensor assembly 20 is disposed between the sucker 10 and the second hollow pipe 30 for connecting the sucker 10 and the second hollow pipe 30. In particular, as shown in FIGS. 6 and 7, the weighing sensor assembly 20 includes two weighing sensors 21, a first hollow pipe 22, a first connecting base 23, a second connecting base 24 and a sealing ring 26. Wherein, the working principle of the weighing sensors 21 is as follows: an elastic body of a strain gauge deforms elastically under action of an external force, so that the resistance strain gauge attached to its surface also deforms therewith. After the deformation of the resistance strain gauge, its resistance will change, and then this resistance change will be converted into an electrical signal through a corresponding measurement circuit, thus completing conversion of the external force into an electrical signal for calculation of a weight of the force borne.

Wherein, the first connecting base 23 is integrally formed with the first hollow pipe 22. The second connecting base 24 includes a connecting base body 241 and an intermediate connecting pipe 242. The second connecting base 24 and the first connecting base 23 are separately arranged, and the two weighing sensors 21 are arranged symmetrically in a space between the first connecting base 23 and the second connecting base 24. The intermediate connecting pipe 242 is connected with the first hollow pipe 22 through a sealing ring 26.

As shown in FIG. 7, the first connecting base 23 and the second connecting base 24 are connected respectively with two ends of the weighing sensors 21. In particular, connection of the first connecting base 23 and the second connecting base 24 with the weighing sensors 21 is provided with a hole A. In order to realize the signal transmission between the weighing signal of the weighing sensors 21 and a controller and other components, the second connecting base 24 of this embodiment is provided with a hole B for passage of a signal transmission line therethrough.

And as shown in FIGS. 5 to 8, in order to provide the pickup tooling of this embodiment with a more compact structure, the first connecting base 23 and the second connecting base 24 of this embodiment are both in a circular structure, and the first connecting base 23 and the second connecting base 24 are coaxially arranged and both of them are coaxial arranged with the second hollow pipe 30. Further, outer diameters of the first connecting base 23 and the second connecting base 24 are slightly larger than an outer diameter of the second hollow pipe 30, so that a volume of the entire weighing sensor assembly 20 can be reduced on the basis of tight connection.

In the technical solution of this embodiment, a weighing sensor of a rated range is replaced with two relatively small weighing sensors 21 which have an unchanged range sum, which are disposed respectively on two sides of the first hollow pipe 22. Upper and lower ends of the two weighing sensors 21 are connected respectively to the corresponding first and second connecting bases. Due to the fact that, in the technical solution of this embodiment, two relatively small weighing sensors on disposed separately on two sides, there is a space for air communication in an intermediate position. Air flows through a hollow position of the first and second connecting bases, generating a vacuum.

When the sucker sucks an article, since the first and second connecting bases are separate, the gravity is borne by the weighing sensors on both sides, and the sealing ring is subjected to a consistent force throughout an entire circumference thereof, ensuring accuracy of feedback of the pressure sensors.

To sum up, according to the technical solution of this embodiment, after the weighing sensors are disposed lower to the end of grasped article, the weighing sensor is split into two parts, such that a center space is used for air communication and is sealed into a structural form for generation of a vacuum. This form can improve the weighing accuracy and reduce the damage probability of the weighing sensor.

Finally, it should be noted that, all the above embodiments are only intended to describe technical solutions of the present disclosure, rather than to limit the same. Although a detailed description is given to the present disclosure with reference to preferred embodiments, a person skilled in the art should understand that, modifications or equivalent replacements may be made to the technical solutions according to the present disclosure, so far as such modifications or equivalent replacements do not go away from the substance and scope of the technical solutions according to the present disclosure.

1. A weighing sensor assembly, comprising a first hollow pipe, and at least two weighing sensors circumferentially and evenly arranged on an outer side of the first hollow pipe at intervals, wherein the at least two weighing sensors are connected to the first hollow pipe.

2. The weighing sensor assembly according to claim 1, wherein the weighing sensor assembly further comprises a connecting base arranged at at least one of axial ends of the first hollow pipe and the connecting base connecting the at least two weighing sensors and the first hollow pipe.

3. The weighing sensor assembly according to claim 2, wherein the weighing sensor assembly comprises a first connecting base and a second connecting base arranged respectively at the axial ends of the first hollow pipe, wherein the first connecting base has a first through-hole and the second connecting base has a second through-hole, and the first hollow pipe is hermetically connected with the first through-hole and the second through-hole.

4. The weighing sensor assembly according to claim 3, wherein the first hollow pipe is integrally formed with the first connecting base.

5. The weighing sensor assembly according to claim 3, wherein the second connecting base comprises a connecting base body and an intermediate connecting pipe arranged on the connecting base body, an inner cavity of the intermediate connecting pipe forms the second throughhole.

6. The weighing sensor assembly according to claim 5, wherein an end of the intermediate connecting pipe away from the first hollow pipe extends beyond a surface of the connecting base body in an axial direction.

7. The weighing sensor assembly according to claim 5, wherein the first hollow pipe is connected with the intermediate connecting pipe through a sealing ring.

8. A pickup tooling, comprising a sucker, a second hollow pipe and the weighing sensor assembly according to claim 1, wherein the sucker comprises a sucker body for sucking an article and a suction tube arranged at an upper end of the sucker body, the second hollow pipe is configured to be connected with a vacuum generator to provide a negative pressure for the sucker; the weighing sensor assembly is disposed between the suction tube and the second hollow pipe, and a lower end of the weighing sensor is connected with the suction tube, and an upper end of the weighing sensor is connected with the second hollow pipe, wherein the suction tube, the first hollow pipe and the second hollow pipe are in air communication sequentially.

9. The pickup tooling according to claim 8, wherein the first hollow pipe (22) is coaxially arranged with the second hollow pipe-, and an inner diameter of the first hollow pipe is smaller than an inner diameter of the second hollow pipe.

10. The pickup tooling according to claim 8, wherein the weighing sensor assembly is arranged adjacent to the sucker.

11. A manipulator, comprising the pickup tooling according to claim 8.

12. A robot, comprising the manipulator according to claim 11.
